(19) United States
(12) Patent Application Publication
(10) Pub. No.: US 2018/0084791 A1
(43) Pub. Date: Mar. 29, 2018

(54) PATTERNED INSERT FOR A FOOD FORMING MACHINE

(71) Applicant: PROVISUR TECHNOLOGIES, INC., Chicago, IL (US)

(72) Inventors: David M. Hansen, Orland Park, IL (US); Joseph A. Ebert, Lockport, IL (US)

(21) Appl. No.: 15/715,812

(22) Filed: Sep. 26, 2017

Related U.S. Application Data
(60) Provisional application No. 62/400,180, filed on Sep. 27, 2016.

(51) Int. Cl. A22C 7/00

(52) U.S. Cl. CPC A22C 7/0092; A22C 7/0069

(57) ABSTRACT

A food forming system includes a rotatable drum, an inner platen, and a first insert plate. The rotatable drum comprises an aperture. The inner platen is disposed in a fixed position within the rotatable drum. The rotatable drum is configured to rotate relative to the inner platen. When the rotatable drum is in a first rotated position the inner platen blocks the aperture, and when the rotatable drum is in a second rotated position the inner platen does not block the aperture. The first insert plate is attached to the rotatable drum directly over the aperture. The first insert plate includes a first food forming pattern having at least one opening.

### CROSS REFERENCE TO RELATED APPLICATIONS

This application claims priority to U.S. Provisional Application No. 62/400,180, filed Sep. 27, 2016, entitled “PATTERNED INSERT FOR A FOOD FORMING MACHINE”, reference of which is hereby incorporated in its entirety.

### FIELD OF THE DISCLOSURE

This disclosure relates to food forming patterns for food forming systems and to their manufacture and use thereof.

### BACKGROUND

Food forming systems are used to form bulk food product into formed food patterns. Some of the current food forming systems are complex, and expensive and timely to manufacture. These complex food forming systems, which are expensive and timely to manufacture, make it difficult, expensive, and timely to vary the food forming patterns to create a variety of formed food patterns. Other food forming systems have one or more differing issues.

A food forming system, and method of its manufacture and use, is needed to overcome one or more issues of one or more of the current food forming systems.

### SUMMARY

In one embodiment of the disclosure, a food forming system is disclosed. The food forming system includes a rotatable drum, an inner platen, and a first insert plate. The rotatable drum comprises an aperture. The inner platen is disposed in a fixed position within the rotatable drum. The rotatable drum is configured to rotate relative to the inner platen. When the rotatable drum is in a first rotated position the inner platen blocks the aperture, and when the rotatable drum is in a second rotated position the inner platen does not block the aperture. The first insert plate is attached to the rotatable drum directly over the aperture. The first insert plate comprises a first food forming pattern comprising at least one opening.

In another embodiment of the disclosure, a food forming system is disclosed. The food forming system includes a rotatable drum, an inner platen, a first insert plate, and a second insert plate. The rotatable drum comprises an aperture. The inner platen is disposed in a fixed position within the rotatable drum. The rotatable drum is configured to rotate relative to the inner platen. When the rotatable drum is in a first rotated position the inner platen blocks the aperture, and when the rotatable drum is in a second rotated position the inner platen does not block the aperture. The first insert plate is attached to the rotatable drum directly over the aperture. The first insert plate comprises a first food forming pattern comprising a first plurality of separate openings. The second insert plate is attachable to the rotatable drum directly over the aperture in place of the first insert plate. The second insert plate comprises a second food forming pattern having a second plurality of separate openings which are different than the first plurality of separate openings of the first food forming pattern.

In yet another embodiment of the disclosure, a method of forming a food product is disclosed. In one step, food product is pumped, while a rotatable drum is disposed in a first rotated position in which an inner platen within the rotatable drum blocks an aperture of the rotatable drum, into at least one opening of a first food forming pattern of a first insert plate attached to and within the aperture of the rotatable drum. In another step, the food product, which is being pumped into the at least one opening of the first food forming pattern of the first insert plate while the rotatable drum is disposed in the first rotated position, is blocked with the inner platen to retain the food product in the at least one opening. In an additional step, the rotatable drum is rotated to a second position in which the inner platen does not block the aperture of the rotatable drum. In another step, the food product formed by the first food forming pattern is moved out of the at least one opening of the first food forming pattern while the rotatable drum is in the second rotated position.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a side view of one embodiment of a food forming system;

FIG. 2 illustrates a top view of the food forming system of the embodiment of FIG. 1;

FIG. 3 illustrates a side-view of a rotatable drum of the embodiment of FIGS. 1 and 2;

FIG. 4 illustrates a perspective view of the rotatable drum of the embodiment of FIG. 3;

FIG. 5 illustrates a disassembled view of the rotatable drum of the embodiment of FIG. 4;

FIG. 6 illustrates a perspective view showing a rotatable drum of the embodiment of FIGS. 3-5 having been rotated to a first rotated position showing the relative positions of the rotatable drum, an inner platen, and a first insert plate without showing the other components shown in FIGS. 3-5 for ease of illustration;

FIG. 7 illustrates a perspective view showing the rotatable drum of the embodiment of FIG. 6 having been rotated to a second rotated position showing the relative positions of the rotatable drum, and the first insert plate without showing the other components shown in FIGS. 3-5 for ease of illustration; and

FIG. 8 illustrates a flow chart of one embodiment of a method of forming a food product.

### DETAILED DESCRIPTION

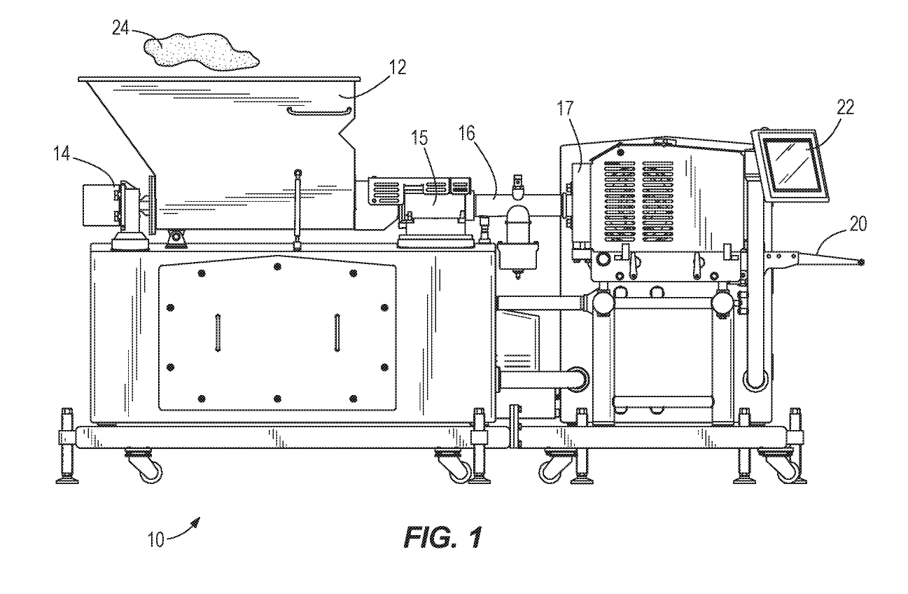

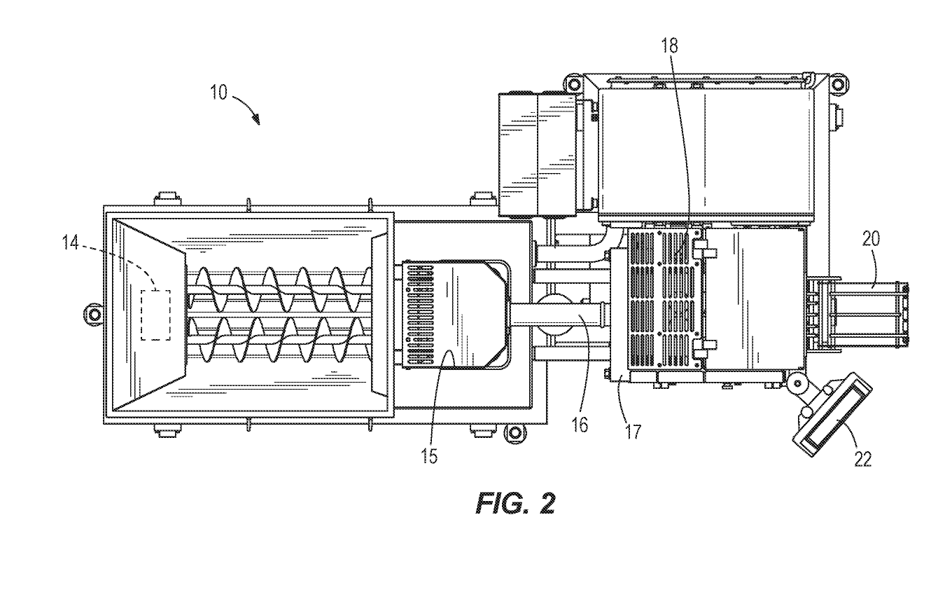

FIG. 1 illustrates a side view of one embodiment of a food forming system 10. FIG. 2 illustrates a top view of the food forming system 10 of the embodiment of FIG. 1. The food forming system 10 of FIGS. 1 and 2 may be used to form patterned food products from a bulk food product. For instance, hamburger patties in a certain pattern may be formed from hamburger meat inserted into the food forming system 10 in bulk. In other embodiments, the food forming system 10 may be used to form varying patterned food products.

As shown in FIGS. 1 and 2 collectively, the food forming system 10 comprises a hopper 12, feed screws 14, a pump 15, a connecting pipe 16, a pump box 17, a rotatable drum 18, a moving member 20, and a control system 22. The bulk food product 24 is loaded into the hopper 12 while the hopper 12 is disposed in a down position as shown. The feed screws 14 feed the bulk food product 24 from the hopper 12, through the pump 15, through the connecting pipe 16, through the pump box 17, and into the rotatable drum 18. As later explained, the rotatable drum 18 forms the bulk food product 24 into a patterned food product. The rotatable drum 18 outputs the patterned food product 24 onto the moving member 20. The moving member 20 moves the patterned food product 24 out of the food forming system 10. The moving member 20 may comprise a conveyor. In other embodiments, the moving member 20 may vary. The control system 22 comprises at least one processor which controls the feed screws 14, the pump 15, the rotatable drum 18, and the moving member 20. In other embodiments, the food forming system 10 may vary.

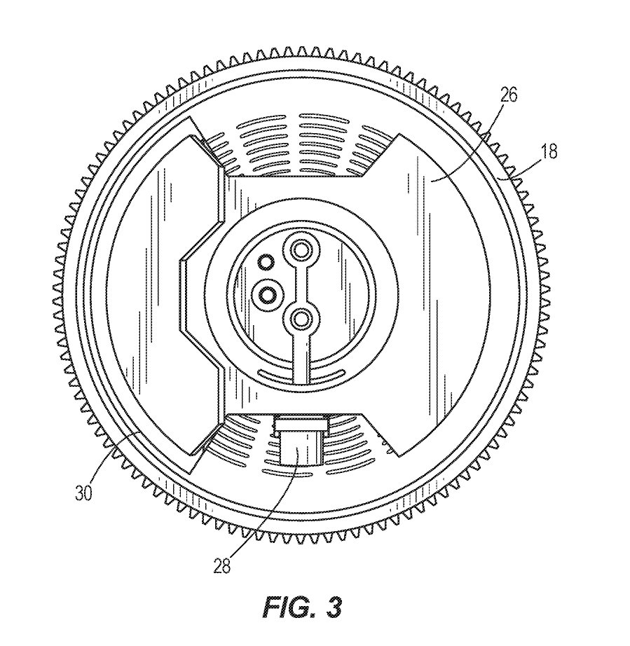

FIG. 3 illustrates a side-view of the rotatable drum 18 of the embodiment of FIGS. 1 and 2. As shown, the rotatable drum 18 is disposed over and rotatably attached to a center shaft 26. The rotatable drum 18 is adapted to rotate around, and relative to, the center shaft 26. A knock-out device 28 is fixedly attached to the center shaft 26 within the rotatable drum 18. The knock-out device 28 is adapted to knock-out formed food product 24 (shown in FIG. 1), which was formed into a pattern by the rotatable drum 18, from the rotatable drum 18 onto the moving member 20 of FIGS. 1 and 2. The knock-out device 28 comprises a mechanically operated member, powered by a motor, which is movable between a retracted position retracted inside the rotatable drum 18 away from the patterned food product 24, and an extended position disposed out of the rotatable drum 18 against the patterned food product 24 to knock-out the formed food product 24 from the rotatable drum 18 onto the moving member 20. In other embodiments, the knock-out device 28 may comprise any number and type of knock-out devices, powered through varying mechanisms, which are adapted to knock-out the formed food product 24 from the rotatable drum 18 onto the moving member 20. An inner platen 30 (which comprises two plates but in other embodiments may comprise any number of plates) is fixedly attached to the center shaft 26 in a fixed position within the rotatable drum 18. The rotatable drum 18 is adapted to rotate around and relative to the inner platen 30.

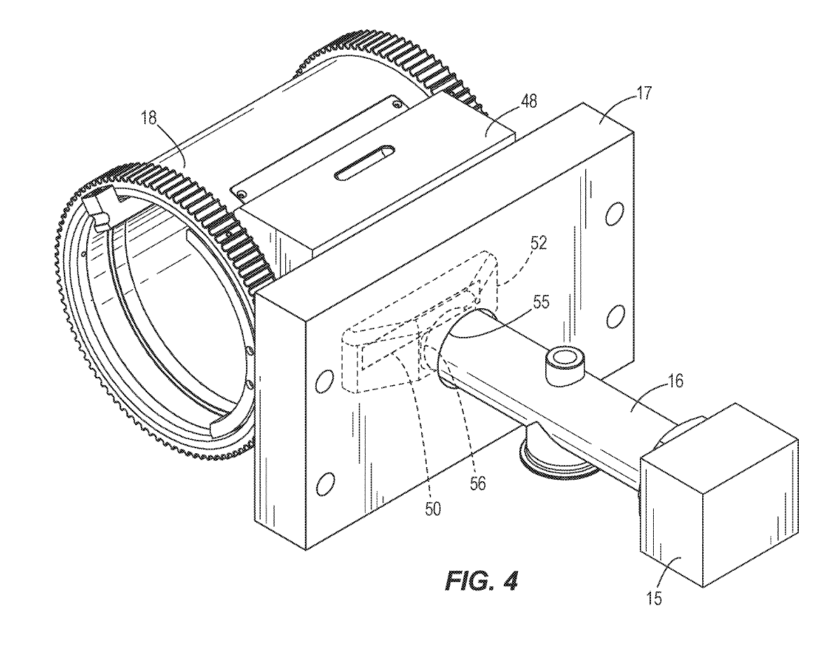

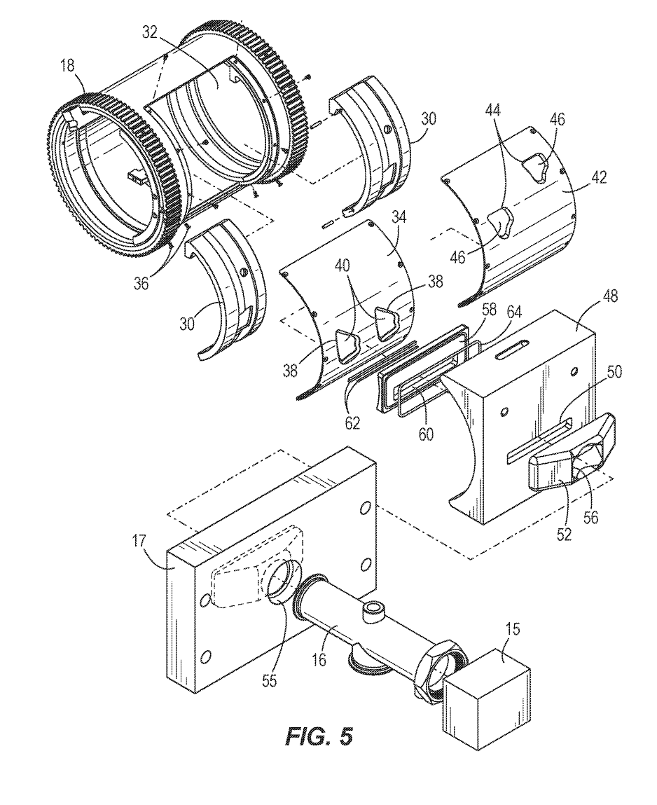

FIG. 4 illustrates a perspective view of the rotatable drum 18 of the embodiment of FIG. 3. FIG. 5 illustrates a disassembled view of the rotatable drum 18 of the embodiment of FIG. 4. As shown collectively in FIGS. 3-5, the rotatable drum 18 comprises an aperture 32. A first insert plate 34 is attached with fasteners 36 to the rotatable drum 18 directly over the aperture 32. The first insert plate 34 comprises a first food forming pattern 38 comprising at least one opening 40 for forming the patterned food products 24 in the pattern of the first food forming pattern 38. In other embodiments, the first food forming pattern 38 may comprise any number, shape, size, or configuration of openings 40. A second insert plate 42, comprising a second food forming pattern 44 comprising at least one different opening 46 than the at least one opening 40 of the first food forming pattern 38, may be substituted for the first insert plate 34 and attached to the rotatable drum 18 with the fasteners 36 to form patterned food products 24 (see FIG. 1) having a different pattern than that formed by the first food forming pattern 38 of the first insert plate 34. In one embodiment, the first food forming pattern 38 of the first insert plate 34 may comprise a first plurality of separate openings 40, and the second food forming pattern 44 of the second insert plate 42 may comprise a second plurality of separate openings 46 different than the first plurality of separate openings 40 of the first forming pattern 38 of the first insert plate 34.

The first and second insert plates 34 and 42 may be manufactured using 3-D printing which is also known to those of ordinary skill in the art as additive manufacturing. In 3-D printing (additive manufacturing), successive layers of material are formed under computer control to create the object. The object can be formed in virtually any shape or geometry and is produced from digital model data, such as a 3D model, or from another electronic data source such as an Additive Manufacturing File (AMF). By using 3-D printing (additive manufacturing) to manufacture the first and second insert plates 34 and 42, varied first and second food forming patterns 38 and 44 may be quickly and inexpensively manufactured in order to form varied shape, size, number, and/or configuration food products. In other embodiments, any number of insert plates may be 3-D manufactured to have varying food forming patterns in order to form varied shape, size, number, and/or configuration food products. In still other embodiments, varied manufacturing processes may be used to manufacture the differing insert plates. For instance, the differing insert plates may be manufactured from plate stock using any manufacturing process known in the art.

An outer platen 48 is disposed in a fixed position outside of the rotatable drum 18. The rotatable drum 18 adapted to rotate relative to the outer platen 48. The outer platen 48 comprises a slot 50. A pump box insert 52 is fixedly attached within and to the pump box 17 over the slot 50 of the outer platen 48. The connecting pipe 16, connected to the pump 15, is connected through a hole 55 of the pump box 17 to a hole 56 of the pump box insert 52 with the connecting pipe 16 being aligned with the hole 55 of the pump box 17, the hole 56 of the pump box insert 52, and the slot 50 of the outer platen 48. A slot-fill member 58 is attached to and within the outer platen 48. A second slot 60 of the slot-fill member 58 is aligned with the slot 50 of the outer platen 48. At least one wiper member 62 is attached to the second slot 60 of the slot-fill member 58. The at least one wiper member 62 is disposed against the first insert plate 34 directly over the at least one opening 40 of the first food forming pattern 38 when the rotatable drum 18 is in a first rotated position in which the inner platen 30 blocks the aperture 32 of the rotatable drum 18. Spring-and-sealing member 64 is attached between the slot-fill member 58 and the outer platen 48. The spring-and-sealing member 64 comprises an O-ring or other force inducing component such as a wave spring. In other embodiments, the spring-and-sealing member 64 may vary in quantity, type, configuration, or size. The spring-and-sealing member 64 is adapted to allow the slot-fill member 58 and the attached at least one wiper member 62 to have some springiness.

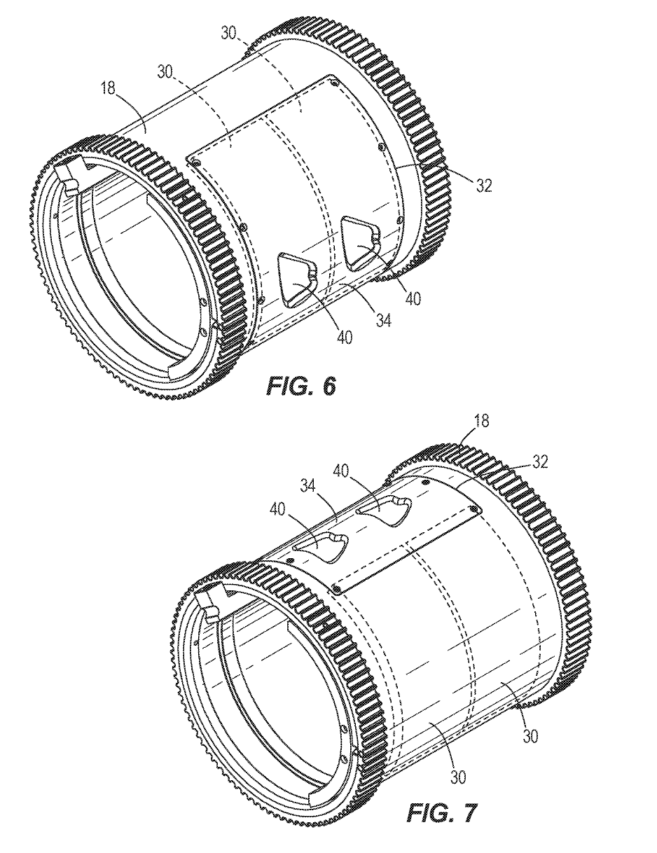

FIG. 6 illustrates a perspective view showing the rotatable drum 18 of the embodiment of FIGS. 3-5 having been rotated to the first rotated position showing the relative positions of the rotatable drum 18, the inner platen 30, and the first insert plate 34 without showing the other components shown in FIGS. 3-5 for ease of illustration. As visualized using FIGS. 1-6 collectively, when the rotatable drum 18 has been rotated to the first rotated position, the inner platen 30 blocks the aperture 32 of the rotatable drum 18 and both the slot 50 of the outer platen 48 and the second slot 60 of the slot-fill member 58 are disposed in alignment with the at least one opening 40 of the first food forming pattern 38. When the rotatable drum 18 is disposed in the first rotated position, the pump 15 is adapted to pump bulk food product 24, which has been inserted into the hopper 12, through the connecting pipe 16, through the hole 55 of the pump box 17, through the hole 56 of the pump box insert 52, through the slot 50 of the outer platen 48, through the second slot 60 of the slot-fill member 58, and into the at least one opening 40 of the first food forming pattern 38 of the first insert plate 34. The inner platen 30 blocks the pumped food product 24, which is pumped into the at least one opening 40 of the first food forming pattern 38 of the first insert plate 34, from going completely through the at least one opening 40 thereby retaining the pumped food product 24 in the at least one opening 40. The at least one wiper member 62, connected to the second slot 60 of the slot-fill member 58, wipes excess food product 24 away from the at least opening of the first food forming pattern 38 of the first insert plate 34 as the rotatable drum 18 rotates from the first rotated position of FIG. 6 to a second rotated position of FIG. 7.

FIG. 7 illustrates a perspective view showing the rotatable drum 18 of the embodiment of FIG. 6 having been rotated to the second rotated position showing the relative positions of the rotatable drum 18, and the first insert plate 34 without showing the other components shown in FIGS. 3-5 for ease of illustration. As visualized using FIGS. 1-5 and 7 collectively, when the rotatable drum 18 has been rotated to the second rotated position, the inner platen 30 no longer blocks the aperture 32 of the rotatable drum 18 and both the slot 50 of the outer platen 48 and the second slot 60 of the slot-fill member 58 are no longer disposed in alignment with the at least one opening 40 of the first food forming pattern 38. When the rotatable drum 18 is disposed in the second rotated position, the knock-out device 28 is aligned with the at least one opening 40 of the first food forming pattern 38 and moves from the retracted position within the rotatable drum 18 retracted away from the at least one opening 40 of the first food forming pattern 38 to the extended position outside the rotatable drum 18 extended within the at least one opening 40 of the first food forming pattern 38 to knock the formed patterned food product 24 out of the at least one opening 40 of the first food forming pattern 38 onto the moving member 20 to be moved out of the food forming system 10. In such manner, food product 24 is formed, from bulk food product, having the pattern of the first food forming pattern 38 of the first insert plate 34. In other embodiments, the knock-out device 28 may comprise any number or type of knock-out devices 28 to simultaneously or separately knock the formed patterned food product 24 out of a plurality of openings 40 of the first food forming pattern 38 onto the moving member 20.

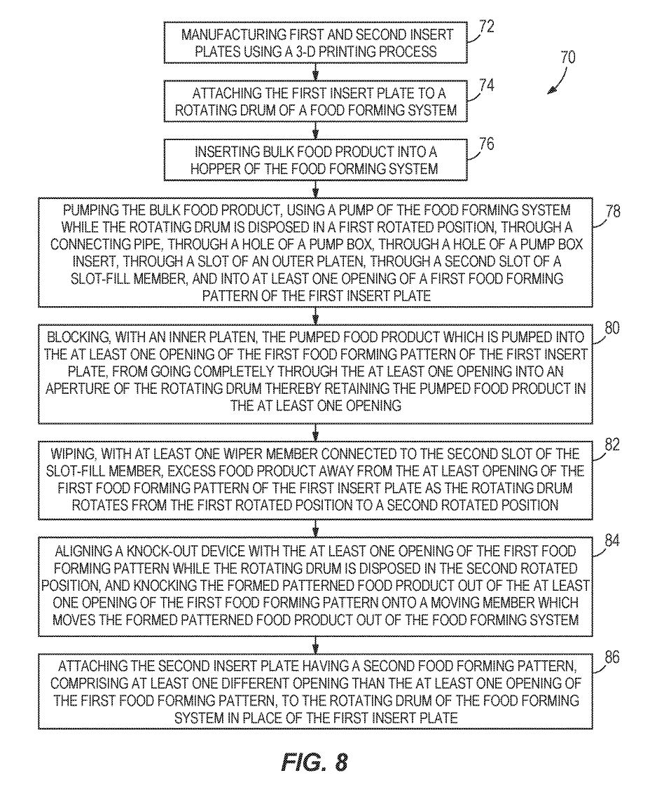

FIG. 8 illustrates a flow chart of one embodiment of a method 70 of forming a food product. Any of the system embodiments of the instant disclosure may be used in implementing the method 70. In other embodiments, varied systems may be used during implementation of the method 70. In step 72, first and second insert plates are manufactured using a 3-D printing (additive manufacturing) process. The first insert plate is manufactured to have a first food forming pattern comprising at least one opening, and the second insert plate is manufactured to have a second food forming pattern having at least one different opening than the at least one opening of the first food forming pattern. In other embodiments, the first and second insert plates may be manufactured using varying methods such as manufacturing the first and second insert plates from plate stock using any process known in the art. In one embodiment, the first insert plate is manufactured to have a first food forming pattern which comprises a first plurality of separate openings, and the second insert plate is manufactured to have a second food forming pattern which comprises a second plurality of separate openings which is different than the first plurality of separate openings of the first insert plate. In step 74, the first insert plate is attached to a rotatable drum of a food forming system. In step 76, bulk food product is inserted into a hopper of the food forming system.

In step 78, while the rotatable drum is disposed in a first rotated position, a pump of the food forming system pumps the bulk food product through a connecting pipe, through a hole of a pump box, through a hole of a pump box insert, through a slot of an outer platen, through a second slot of a slot-fill member, and into the least one opening of the first food forming pattern of the first insert plate. In step 80, an inner platen blocks the pumped food product, which is pumped into the at least one opening of the first food forming pattern of the first insert plate, from going completely through the at least one opening into the aperture of the rotatable drum thereby retaining the pumped food product in the at least one opening. In step 82, at least one wiper member, connected to the second slot of the slot-fill member, wipes excess food product away from the at least opening of the first food forming pattern of the first insert plate as the rotatable drum rotates from the first rotated position to a second rotated position. In the second rotated position, the inner platen no longer blocks the aperture of the rotatable drum and both the slot of the outer platen and the second slot of the slot-fill member are no longer disposed in alignment with the at least one opening of the first food forming pattern.

In step 84, while the rotatable drum is disposed in the second rotated position, a knock-out device is aligned with the at least one opening of the first food forming pattern and moves from a retracted position within the rotatable drum retracted away from the at least one opening of the first food forming pattern to an extended position outside the rotatable drum extended within the at least one opening of the first food forming pattern to knock the formed patterned food product out of the at least one opening of the first food forming pattern onto a moving member which moves the formed patterned food product out of the food forming system. In other embodiments, any number or type of knock-out devices may be used simultaneously or separately to knock the formed patterned food product out of a plurality of openings of the first food forming pattern onto the moving member. In step 86, the second insert plate having the second food forming pattern comprising at least one different opening than the at least one opening of the first food forming pattern is attached to the rotatable drum of the food forming system in place of the first insert plate. Subsequently, steps 76-84 are repeated using the second insert plate instead of the first insert plate to form food product having a varied pattern than that formed using the first insert plate.

In other embodiments, one or more steps of the method 70 may be modified in substance or in order, one or more steps of the method 70 may not be followed, or one or more additional steps may be added.

The food forming systems and methods of the instant disclosure save cost, expense, and time of manufacture over one or more of the current food forming systems and methods of use or manufacture. These food forming systems and methods may have further benefits over one or more of the current food forming systems and methods of use or manufacture.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A food forming system comprising:
a rotatable drum comprising an aperture;
an inner platen disposed in a fixed position within the rotatable drum, wherein the rotatable drum is configured to rotate relative to the inner platen, when the rotatable drum is in a first rotated position the inner platen blocks the aperture, and when the rotatable drum is in a second rotated position the inner platen does not block the aperture; and
a first insert plate attached to the rotatable drum directly over the aperture, the first insert plate comprising a first food forming pattern comprising at least one opening.

2. The food forming system of claim 1 wherein the first food forming pattern comprises a plurality of openings.

3. The food forming system of claim 1 further comprising a second insert plate attachable to the rotatable drum directly over the aperture in place of the first insert plate, the second insert plate comprising a second food forming pattern having at least one different opening than the at least one opening of the first food forming pattern.

4. The food forming system of claim 1 further comprising a knock-out device disposed within the rotatable drum, wherein the knock-out device is aligned with the at least one opening of the first food forming pattern when the rotatable drum is in the second rotated position, the knock-out device movable between a retracted position within the rotatable drum retracted away from the at least one opening of the first food forming pattern to an extended position outside the rotatable drum extended within the at least one opening of the first food forming pattern to knock-out formed food product disposed within the at least one opening of the first food forming pattern.

5. The food forming system of claim 1 further comprising an outer platen disposed in a fixed position outside of the rotatable drum, wherein the rotatable drum is configured to rotate relative to the outer platen, when the rotatable drum is in the first rotated position a slot of the outer platen is disposed in alignment with the at least one opening of the first food forming pattern, and when the rotatable drum is in the second rotated position the slot of the outer platen is not disposed in alignment with the at least one opening of the first food forming pattern.

6. The food forming system of claim 5 further comprising at least one wiper member attached with the outer platen, wherein when the rotatable drum is in the first rotated position the at least one wiper member is disposed against the first insert plate directly over the at least one opening of the first food forming pattern.

7. The food forming system of claim 6 further comprising a slot-fill member comprising a second slot, wherein the second slot is aligned with the slot of the outer platen and the at least one wiper member is attached to the slot-fill member.

8. The food forming system of claim 7 further comprising a spring-and-sealing member attached between the slot-fill member and the outer platen.

9. The food forming system of claim 5 further comprising a pump box and a pump, the pump box attached with the outer platen over the slot of the outer platen, and the pump configured, when the rotatable drum is in the first rotated position, to pump food product through the slot of the outer platen into the at least one opening of the first food forming pattern.

10. The food forming system of claim 9 further comprising a connecting pipe attached between the pump and the pump box, and a pump box insert disposed within the pump box, the pump box insert having a first hole disposed in alignment with a second hole of the pump box with both the first and the second holes being disposed in alignment with the slot of the outer platen, the pump box insert attached to the connecting pipe.

11. A food forming system comprising:
a rotatable drum comprising an aperture;
an inner platen disposed in a fixed position within the rotatable drum, wherein the rotatable drum is configured to rotate relative to the inner platen, when the rotatable drum is in a first rotated position the inner platen blocks the aperture, and when the rotatable drum is in a second rotated position the inner platen does not block the aperture;
a first insert plate attached to the rotatable drum directly over the aperture, the first insert plate comprising a first food forming pattern comprising a first plurality of separate openings; and
a second insert plate attachable to the rotatable drum directly over the aperture in place of the first insert plate, the second insert plate comprising a second food forming pattern having a second plurality of separate openings which are different than the first plurality of separate openings of the first food forming pattern.

12. The food forming system of claim 11 further comprising at least one knock-out device disposed within the rotatable drum, wherein the at least one knock-out device is aligned with the first plurality of separate openings of the first food forming pattern when the rotatable drum is in the second rotated position, the at least one knock-out device movable between a retracted position within the rotatable drum retracted away from the first plurality of separate openings of the first food forming pattern to an extended position outside the rotatable drum to simultaneously or separately knock-out formed food product disposed within the first plurality of separate openings of the first food forming pattern.

13. A method of forming a food product comprising:
pumping food product, while a rotatable drum is disposed in a first rotated position in which an inner platen within the rotatable drum blocks an aperture of the rotatable drum, into at least one opening of a first food forming pattern of a first insert plate attached to and within the aperture of the rotatable drum;
blocking the food product, which is being pumped into the at least one opening of the first food forming pattern of the first insert plate while the rotatable drum is disposed in the first rotated position, with the inner platen to retain the food product in the at least one opening;
rotating the rotatable drum to a second rotated position in which the inner platen does not block the aperture of the rotatable drum; and
moving the food product formed by the first food forming pattern out of the at least one opening of the first food forming pattern while the rotatable drum is in the second rotated position.

14. The method of claim 13 further comprising detaching the first insert plate from the aperture of the rotatable drum, attaching a second insert plate comprising a second food forming pattern different than the first food forming pattern to and within the aperture of the rotatable drum, and repeating all steps of the method with the second insert plate.

15. The method of claim 13 further comprising the first insert plate comprising a plurality of openings, and following the method to form the food product using the plurality of openings of the first insert plate.

16. The method of claim 13 wherein the moving the food product formed by the first food forming pattern out of the at least one opening of the first food forming pattern while the rotatable drum is in the second rotated position further comprises moving a knock-out device disposed within the rotatable drum from a retracted position retracted away from the at least one opening of the first food forming pattern to an extended position outside the rotatable drum extended within the at least one opening of the first food forming pattern to knock-out the food product formed by the first food forming pattern.

17. The method of claim 13 wherein the pumping the food product, while the rotatable drum is disposed in the first rotated position in which the inner platen within the rotatable drum blocks the aperture of the rotatable drum, into the at least one opening of the first food forming pattern of the first insert plate attached to and within the aperture of the rotatable drum further comprises pumping the food product, while the rotatable drum is disposed in the first rotated position, through a slot of an outer platen, disposed outside of the rotatable drum in a fixed position, into the least one opening of the first food forming pattern of the first insert plate.

18. The method of claim 17 wherein the pumping the food product, while the rotatable drum is disposed in the first rotated position in which the inner platen within the rotatable drum blocks the aperture of the rotatable drum, into the at least one opening of the first food forming pattern of the first insert plate attached to and within the aperture of the rotatable drum further comprises pumping the food product, while the rotatable drum is disposed in the first rotated position, through a hole of a pump box, through a hole of a pump box insert, through the slot of the outer platen, into the at least one opening of the first food forming pattern of the first insert plate.

19. The method of claim 18 wherein the pumping the food product, while the rotatable drum is disposed in the first rotated position in which the inner platen within the rotatable drum blocks the aperture of the rotatable drum, into the at least one opening of the first food forming pattern of the first insert plate attached to and within the aperture of the rotatable drum further comprises pumping the food product, while the rotatable drum is disposed in the first rotated position, from a pump, through a connecting pipe, through the hold of the pump box, through the hole of the pump box insert, through the slot of the outer platen, through a second slot of a slot-fill member, into the at least one opening of the first food forming pattern of the first insert plate.

20. The method of claim 13 further comprising, as the rotatable drum rotates from the first rotated position towards the second rotated position, at least one wiper member wiping excess food product away from the at least one opening of the first food forming pattern of the first insert plate.
